(19) United States
(12) Patent Application Publication
(10) Pub. No.: US 2006/0120468 A1
(43) Pub. Date: Jun. 8, 2006

(54) Method and system for guard interval size detection

(76) Inventors: Che-Li Lin, Taipei City (TW); Chih-Cheng Chen, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/003,919

(22) Filed: Dec. 3, 2004

(51) Int. Cl. H04K 1/10; H04L 27/06

(52) U.S. Cl. 375/260; 375/343

(57) ABSTRACT

Methods and systems for detecting a guard interval size in a received OFDM signal are provided. A correlation calculator calculates a preliminary correlation signal based on a digitized signal, and generates a correlation signal corresponding to each possible guard interval size by summing the preliminary correlation signal in accordance with the possible guard interval size. Characteristics such as maximum value NM and number of points above a threshold Np in a sample period for each correlation signal are determined and compared, and the actual guard interval size is selected according to the determined characteristics.

### BACKGROUND

The invention relates to a digital television (DTV) system, more specifically to methods and systems for detecting a guard interval size in a received Orthogonal Frequency Division Multiplexing (OFDM) signal.

Digital Video Broadcasting-Terrestrial (DVB-T) is a standard for wireless broadcast of video signals using OFDM with concatenated error coding. OFDM is a multi-carrier communication scheme for data transmission over multi-path channels. Information transmitted over different carriers can be properly separated as the carriers of an OFDM signal are orthogonal to each other.

Inter-symbol interference (ISI) induced by multi-path channels can be minimized by including a cyclic prefix guard interval in each active symbol in OFDM signals. The guard interval of a current active symbol is a tail portion of a previous symbol repeated before the current active symbol. Reflections of the previous symbol can be completely removed and the perpendicular can be preserved if the guard interval is longer than the maximum channel delay. The duration of the guard interval is variable as the presence of the guard interval reduces the transmission channel efficiency. The size of the guard interval is thus selected in accordance with transmission quality and conditions so that a desired tradeoff between ISI mitigation capability and channel capacity can be obtained.

The size of the guard intervals is unknown when the OFDM signal is received by a DVB-T receiver. The DVB-T receiver thus requires a blind detection mechanism for determining the guard interval size in order to remove the prefix guard intervals from the OFDM signal.

The OFDM signal is organized in frames, each having 68 OFDM symbols. Each received OFDM symbol comprises a useful part N and a guard interval, and is constituted by a set of K=6817 carriers in an 8K mode or K=1705 carriers in a 2K mode. Three modes provided in current DTV specifications are 2K mode, 4K mode, and 8K mode, and the OFDM symbol sizes are 2048, 4096, and 8192 respectively. There are four different guard interval sizes, N/32, N/16, N/8, and, N/4, that may be used for adapting different transmission conditions, where N is the length of the useful part, also referred to as the OFDM symbol period, N=2048 for the 2K mode and N=8192 for the 8K mode.

### SUMMARY

Methods and systems for detecting a guard interval size among a predetermined number of possible guard interval sizes in a received OFDM signal are provided. Some embodiments of a detection method comprise digitizing the received OFDM signal to form digital samples, and calculating a preliminary correlation signal from the digital samples. The preliminary correlation signal is derived in accordance with each possible guard interval size to generate a correlation signal corresponding to each possible guard interval size. For each correlation signal, a maximum value N_{M} and a number of points above a threshold N_{P} in a sample period W are determined. One of the possible guard interval sizes is chosen as the detected guard interval size according to the values N_{M} and N_{P} of each correlation signal.

In some embodiments, the validity of the detected guard interval size is determined based on a maximum value position N_{I} obtained in a current and a previous sample period. The detected guard interval is determined as invalid if the maximum value positions do not occur periodically.

Some embodiments of a detection system comprise an analog to digital converter (ADC), a correlation calculator, a characteristic extractor, and an information combiner. The ADC digitizes the received OFDM signal to form digital samples and provides the digital samples to the correlation calculator. The correlation calculator calculates a preliminary correlation signal from the digital samples, and generates a correlation signal corresponding to each of the possible guard interval sizes by summing the preliminary correlation signal in accordance with the possible guard interval size. The characteristic extractor determines characteristics such as a maximum value N_{M} and a number of points above a threshold N_{P} in a sample period W for each correlation signal. The information combiner receives the characteristics from the characteristic extractor, and chooses the guard interval size as the detected guard interval size from one of the possible guard interval sizes according to the values N_{M} and N_{P} of each correlation signal.

A synchronization monitoring mechanism maintaining the system synchronization according to a guard interval size detected in a received OFDM signal is also provided. The synchronization monitoring mechanism comprises an ADC, a correlation calculator, a characteristic extractor, an information combiner, and a synchronization controller. The ADC converts the received OFDM signal into digital samples. The correlation calculator calculates a preliminary correlation signal from the digital samples, and generates a correlation signal corresponding to each possible guard interval size by adding the preliminary correlation signal in accordance with the possible guard interval size. The characteristic extractor determines a maximum value NM, a number of points above a threshold Np, and a maximum value position N, for each correlation signal in a sample period W for each correlation signal. The information combiner receives the output of the characteristic extractor, chooses the guard interval size as the detected guard interval size from one of the possible guard interval sizes according to the values N_{M} and N_{P} of each correlation signal, and checks validity of the detected guard interval size based on the maximum value position N_{I}. The synchronization controller records a pass count for the number of times a detected guard interval size passes the validity check. A fail count is recorded for the number of times a detected guard interval size fails the validity check, and confirms the detected guard interval size if the pass count exceeds a confirm threshold. It is further determined if the confirmed guard interval size is different from the previous guard interval size. Re-synchronizing is performed if the fail count exceeds a valid threshold or the confirmed guard interval size is different.

### DESCRIPTION OF THE DRAWINGS

Methods and systems for detecting a guard interval size can be more fully understood by reading the subsequent detailed description in conjunction with the examples and references made to the accompanying drawings, wherein:

FIG. 1 illustrates an embodiment of a system for detecting a guard interval size in a DVB-T system.

FIGS. 2A and 2B show a block diagram illustrating an embodiment of a detection system.

FIG. 3 illustrates exemplary correlation signals after moving sum and absolute value calculations, where GI=N/8.

FIG. 4 is a block diagram illustrating an embodiment of a characteristic extractor.

FIG. 5 is a block diagram illustrating an embodiment of an information combiner.

FIG. 6 is a flowchart showing an embodiment of validation check according to the maximum value positions.

FIG. 7 shows exemplary correlation signals under two timing conditions.

FIG. 8 is a flowchart showing an embodiment of a confirmation block.

FIG. 9 is a flowchart showing an embodiment of a confirmation block for a synchronization monitoring mechanism.

FIGS. 10A and 10B show a block diagram illustrating an embodiment of a detection system.

FIG. 11 illustrates an embodiment of an accumulation block.

FIGS. 12A and 12B show a block diagram illustrating an embodiment of a detection system.

### DETAILED DESCRIPTION

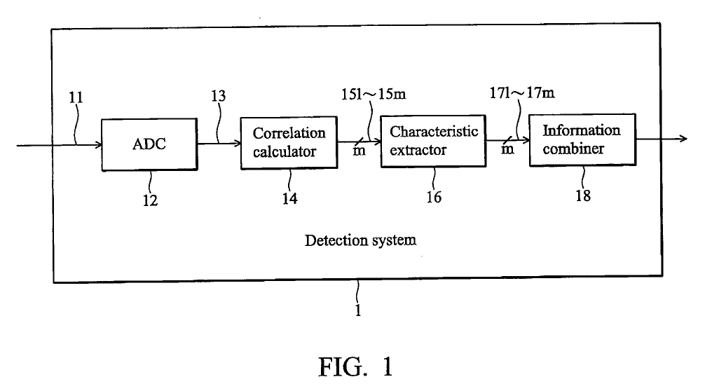

An exemplary receiver detects the guard interval size of a received signal using a detection system 1 as shown in FIG. 1. The detection system 1 comprises an analog to digital converter (ADC) 12, a correlation calculator 14, a characteristic extractor 16, and an information combiner 18. The ADC 12 converts a received signal 11 into digital samples 13, and provides the digital samples 13 to the correlation calculator 14. The correlation calculator 14 computes a preliminary correlation signal by self-correlating the digital samples 13 output from the ADC 12, and generating m correlation signals 151˜15m, each corresponding to one of the m possible guard interval sizes. The characteristic extractor 16 determines m sets of characteristics 171˜17m in a sample period for each correlation signal 151˜15m, each set of characteristics 171˜17m comprises a maximum value N_{M} and a number of points above a threshold N_{P}. The information combiner 18 compares the sets of parameters 171˜17m obtained from the m correlation signals 151˜15m, generates a comparison result, and chooses the guard interval size according to the comparison result. In an embodiment, the correlation signals are provided to a metric block before being provided to the characteristic extractor. The metric block generates metric values for each correlation signal. The characteristic extractor determines the characteristics based on the metric values.

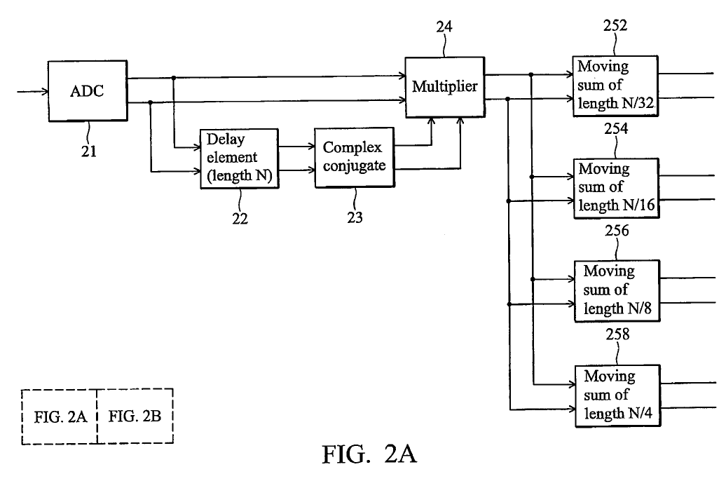

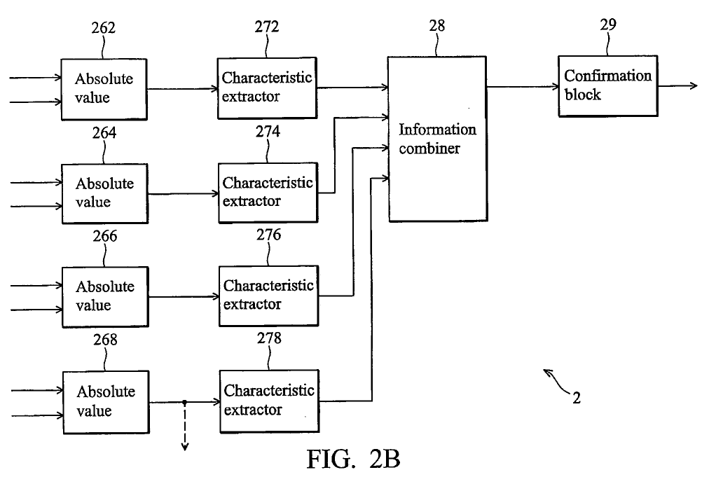

In some embodiments of a DVB-T system, the transmitter may adopt one of four guard interval sizes (m=4) N/32, N/16, N/8, and N/4 in an OFDM signal, where N is the length of the useful data in a symbol, which is also referred to as the OFDM symbol period. FIGS. 2A and 2B illustrate a detection system 2 for determining the guard interval size of a signal received by a receiver of the DVB-T system. An analog to digital converter (ADC) 21 digitizes the signal received from a radio frequency (RF) or an intermediate frequency (IF) module (not shown) of the receiver. A multiplier 24 multiplies the digital signal output from the ADC 21 and a delayed digital signal, which is obtained by passing the digital signal through a delay element 22 and a complex conjugate unit 23, to obtain a preliminary correlation signal. The preliminary correlation signal indicates the similarity between samples of the digital signal.

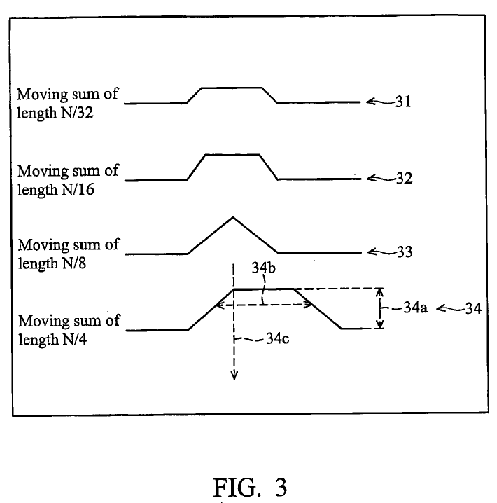

The preliminary correlation signal is then provided to four moving sum blocks 252, 254, 256, and 258, and four absolute value blocks 262, 264, 266, and 268 to obtain four correlation signals, wherein each correlation signal is computed based on one of the four possible guard interval sizes. FIG. 3 shows exemplary correlation signals after moving sum blocks 252˜258 and absolute value blocks 262˜268. The correlation signals 31˜34 show the moving sums of the preliminary correlation signal when the accumulated lengths are N/32, N/16, N/8, N/4 respectively. FIG. 3 illustrates an example of a guard interval size equal to N/8. There is a sharp peak in the correlation signal 33 which denotes a high correlation compared to the remaining correlation signals 31, 32, and 34.

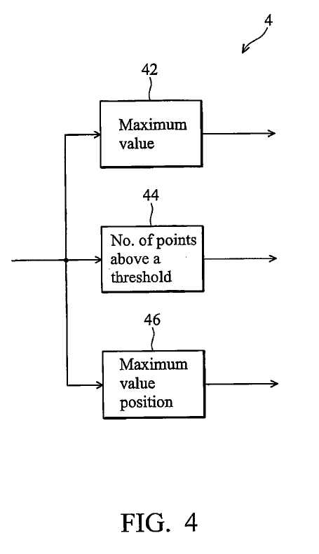

Characteristic extractors (CE) 272, 274, 276, and 278 of FIGS. 2A and 2B receive the correlation signals obtained by the corresponding absolute value blocks 262˜268, and each CE 272˜278 generates extracted characteristics including maximum value N_{M}, maximum value position N_{I}, and number of points above a threshold N_{P} of each symbol in the corresponding correlation signal. FIG. 4 is a block diagram illustrating an exemplary characteristic extractor (CE) 4. The CE 4 comprises three blocks 42, 44, and 46, determining a maximum value N_{M}, a number of points above a threshold N_{P}, and a maximum value position N_{I} respectively.

The correlation signal 34 illustrated in FIG. 3 demonstrates the meaning of maximum value (N_{M}) 34a, maximum value position (N_{I}) 34c, and number of points above a threshold (N_{P}) 34b. The threshold for determining the value N_{P} can also be determined by multiplying an average of at least one preceding maximum value N_{M} and a value less than 1, for example 0.7. In the case of an accumulated length equal to the actual guard interval size, the extracted maximum value N_{M} is expected to be large, and the extracted number of points above the threshold N_{P} is expected to be small compared to the correlation signals retrieved based on other accumulated lengths. As shown in FIG. 3, since the actual guard interval size is N/8, the correlation signal 33 (obtained by the moving sum of N/8) thus has a sharp peak with a large maximum value and a small number of points above the threshold. In comparison, the other three correlation signals 31, 32, and 34 do not show a sharp peak, which means that the corresponding numbers of points above the thresholds are larger compared to correlation signal 33. The maximum value positions N_{I} extracted from the correlation signal obtained by the actual accumulated length are expected to occur periodically, and therefore, the maximum value positions N_{I} can be an indicator for examining the validity of the determined guard interval size.

In FIGS. 2A and 2B, the CEs 272˜278 provide the extracted characteristics to an information combiner 28 separately, and the information combiner 28 determines the guard interval size according to the maximum values N_{M} and the numbers of points above the threshold N_{P}. The information combiner 28 also checks the validity of the determined guard interval size according to the maximum value positions N_{I}. A confirmation block 29 confirms the guard interval determined by the information combiner 28 in order to improve system accuracy. The value of the OFDM symbol period N assumed by the system becomes invalid if the information combiner 28 outputs too many invalid results from the validation check, as all possible guard interval sizes fail to obtain a valid result.

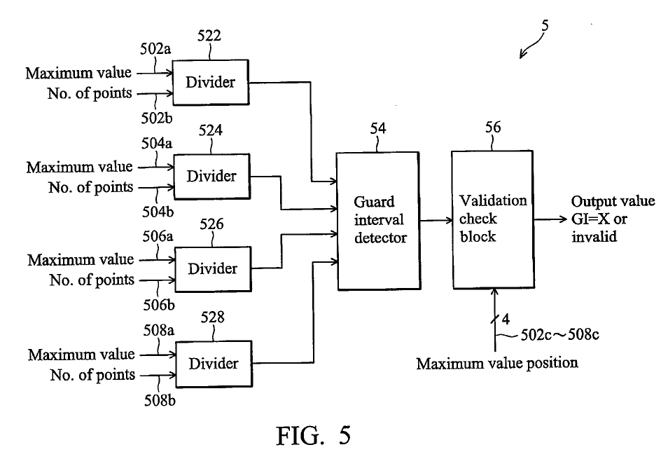

FIG. 5 is a block diagram illustrating an embodiment of an information combiner 5. The information combiner 5 comprises four dividers 522, 524, 526, and 528, a guard interval detector 54, and a validation check block 56. Each divider 522˜528 obtains a maximum value 502a, 504a, 506a, and 508a, and a number of points above a threshold 502b, 504b, 506b, and 508b, from a corresponding characteristic extractor, and calculates a ratio between the maximum value N_{M} and the number of points N_{P} (N_{M}/N_{P}). The guard interval detector 54 thus receives four ratios calculated by the dividers 522˜528 respectively and determines the guard interval size by selecting a greatest ratio among the four ratios. The validation check block 56 retrieves four maximum value positions 502c, 504c, 506c, and 508c from the four characteristic extractors, and checks whether the maximum value position corresponding to the greatest ratio is a valid position.

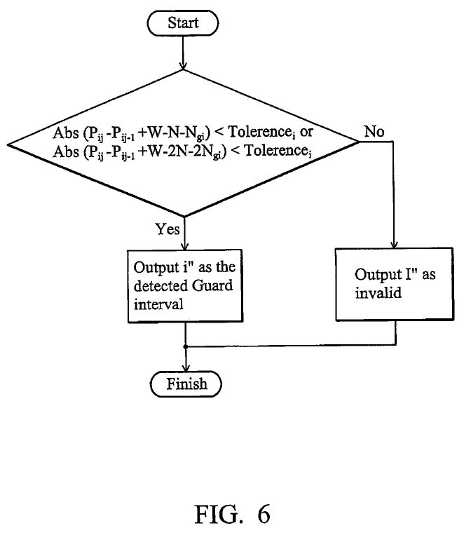

The maximum value positions are expected to be periodical and the period is supposed to be N+N_{gi}, where N_{gi} is the guard interval size. FIG. 6 is a flowchart illustrating the procedures for validation checking by position performed by an exemplary validation check block. The sample period W for each characteristic extractor to extract a maximum value N_{M}, maximum value position N_{I}, and number of points N_{P} is a variable window size for the characteristic extractor. W must be greater than the maximum possible period (N+N_{gi}), and in this case, the maximum guard interval size is N/4, so W must be 1.25 times greater than the OFDM symbol period (W>1.25N). In this case, we set W=1.5N for example. The validation check block compares calculated errors with preset tolerance values. The errors are calculated as shown by the following equations:
Error1=Abs [(Pᵢⱼ+W)−Pᵢⱼ₋₁−N−N_{gi}]; [1]
Error2=Abs [(Pᵢⱼ+W)−Pᵢⱼ₋₁−2N−2N_{gi}]; [2]

Where i denotes the guard interval size, i=1 for guard interval GI=N/32, i=2 for GI=N/16, i=3 for GI=N/8, and i=4 for GI=N/4, and j denotes the j^{th} result for maximum value position, for each window size W, one result Pᵢⱼ corresponding to each GI is obtained. N_{gi} denotes the guard interval size for guard interval i, for example, N_{gi}=N/32, N_{g2}=N/16, N_{g3}=N/8 and N_{g4}=N/4.

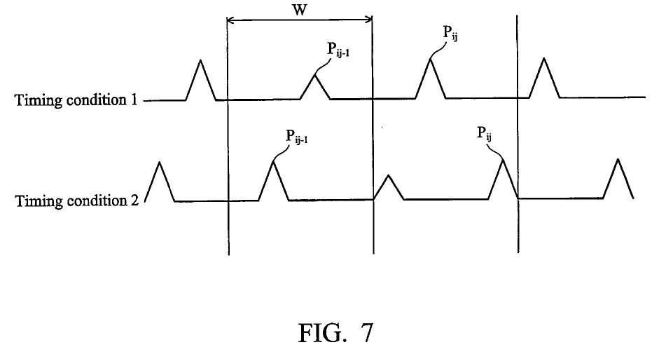

By considering two possible timing conditions, error1 and error2calculated by Equations [1] and [2], compares the distances between two extracted maximum values to one symbol period and two symbol periods respectively. FIG. 7 shows exemplary correlation signals for depicting the two timing conditions. In timing condition 1, the distance between two consecutive maximum value positions N_{I} is supposed to equal one symbol period (N+N_{gi}), whereas the distance between two consecutive maximum value positions N_{I} is supposed to equal two symbol periods (2N+2N_{gi}) under timing condition 2. Either error1 or error2 calculated by Equations [1] and [2] must be less than a preset tolerance, or else the determined guard interval size is invalid.

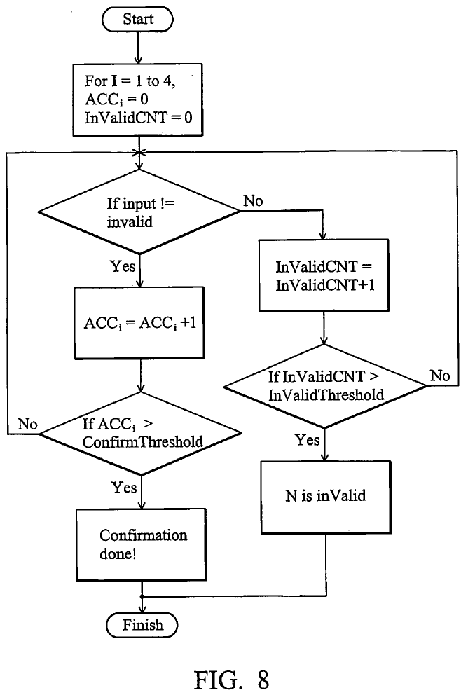

FIG. 8 is a flowchart illustrating the procedures executed by an embodiment of a confirmation block. The confirmation block receives the output of the information combiner, counts the number of invalid results according to the validation check by position, and accumulates each valid guard interval size ACCᵢ determined by the information combiner. The OFDM symbol period N is determined to be invalid if the number of invalid results exceeds a predetermined invalid threshold. If any of the guard interval size counts exceeds a predetermined confirm threshold, the confirmation is successful.

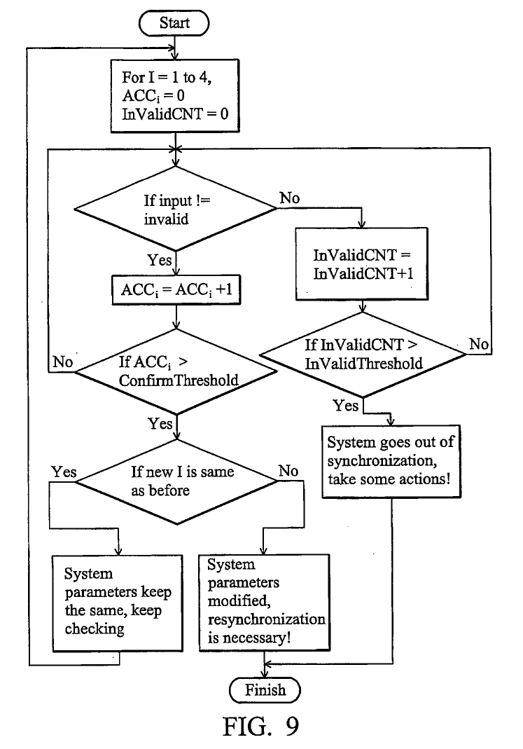

The system for detecting the guard interval consumes only a small portion of memory, thus in some embodiments, the system operates as a synchronization monitoring mechanism after detecting the guard interval. In an embodiment, the synchronization monitoring mechanism comprises a previously described detection system and a synchronization controller. FIG. 9 shows the flowchart for an embodiment of a confirmation block and a synchronization controller in a synchronization monitoring mechanism. The flowchart of FIG. 9 further checks whether the newly detected and previous guard interval sizes are the same. Once the newly detected guard interval size changes, the system parameters must be modified, and resynchronization is required. If the newly detected guard interval size remains the same, indicating that the system is synchronized, the synchronization monitoring mechanism keeps checking. The predetermined invalid threshold and confirm threshold can be selected in accordance with the desired objective.

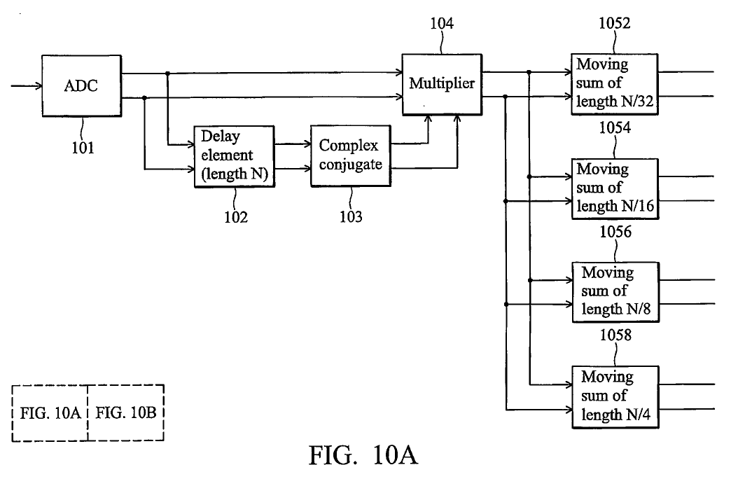

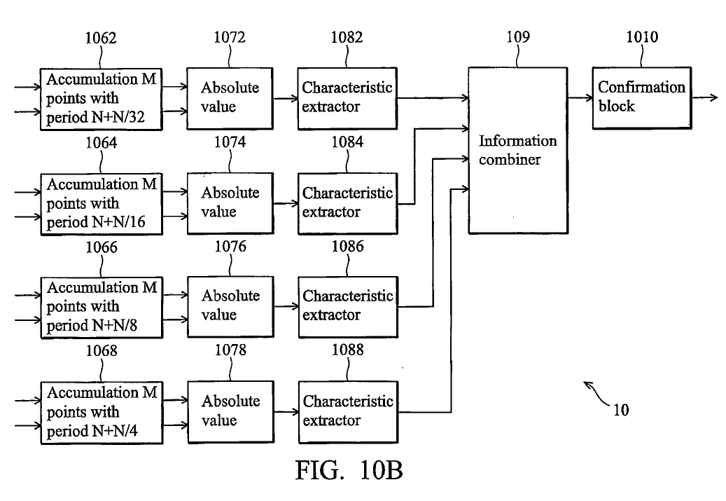

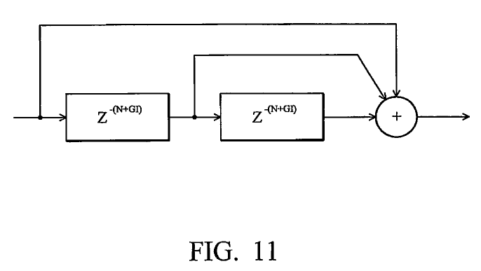

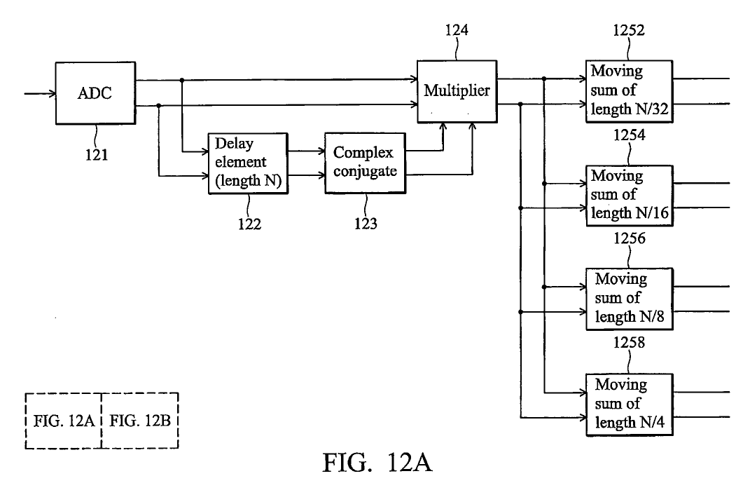

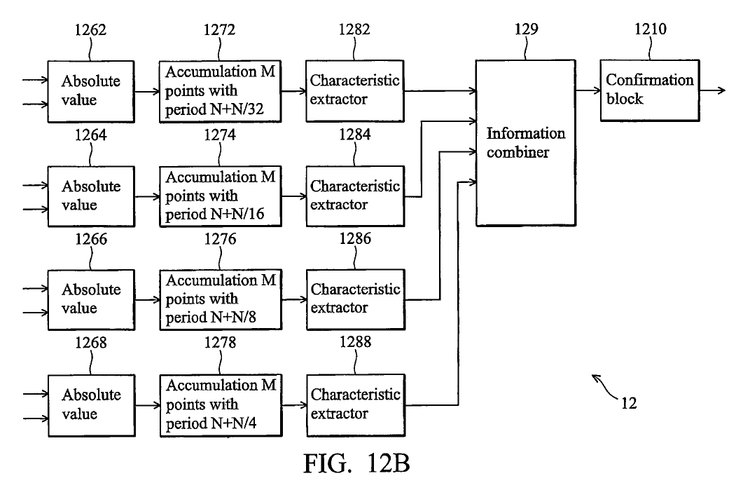

FIGS. 10A and 10B show a block diagram illustrating an embodiment of a detection system 10. In the detection system 10, additional accumulation blocks 1062, 1064, 1066, and 1068 are inserted between the moving sum blocks 1052˜1058 and the absolute value blocks 1072˜1078, for increasing the signal to noise ratio (SNR) of the system. The multiplier 104 provides digital samples to the moving sum blocks 1052˜1058. Each accumulation block 1062˜1068 accumulates M points with period N+GI, where GI is the expected guard interval size. For example, GI equals to N/32 for the accumulation block 1062. FIG. 11 shows an embodiment of an accumulation block which accumulates every three points (M=3) spaced N+GI apart. FIGS. 12A and 12B show a block diagram illustrating an embodiment of a detection system 12. The accumulation blocks 1272, 1274, 1276, and 1278 are inserted between the absolute value blocks 1262˜1268 and the characteristic extractors 1282˜1288 in the detection system 12. The preliminary signals are accumulated after the moving sum and obtaining the absolute values. The accumulation blocks may enhance system performance, but the system requires more memory for implementing the accumulation blocks.

While the invention has been described by way of example and in terms of preferred embodiments, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for detecting a guard interval size among a predetermined number of possible guard interval sizes in a received Orthogonal Frequency Division Multiplexing (OFDM) signal, comprising:
digitizing the received OFDM signal to form digital samples;
calculating a preliminary correlation signal from the digital samples;
generating a correlation signal corresponding to each possible guard interval size by summing the preliminary correlation signal in accordance with the possible guard interval size;
determining a maximum value N_{M} and a number of points above a threshold N_{P} in a sample period W for each correlation signal; and
choosing the guard interval size as the detected guard interval size from one of the possible guard interval sizes according to the values N_{M} and N_{P} of each correlation signal.

2. The method according to claim 1, wherein the maximum value N_{M} and the number of points above the threshold N_{P} obtained from each correlation signal are determined by obtaining metric values of each correlation signal in the sample period W, searching a peak among the metric values as N_{M}, and counting a number of metric values above the threshold as N_{P}.

3. The method according to claim 2, wherein the metric values are absolute values of each correlation signal in the sample period.

4. The method according to claim 1, further comprising locating a maximum value position N_{I} in the sample period for each correlation signal.

5. The method according to claim 4, further comprising determining validity of the detected guard interval size based on the maximum value position N_{I} obtained in a current and a previous sample period.

6. The method according to claim 5, wherein the detected guard interval size is valid if the maximum value position N_{I} occurs periodically.

7. The method according to claim 5, further comprising confirming the detected guard interval size by counting a number of times the detected guard interval size passes the validity check and comparing the number with a confirm threshold.

8. The method according to claim 1, wherein the sample period W is greater than 1.25 times the OFDM symbol period N (W>1.25N).

9. The method according to claim 1, wherein the guard interval size is chosen by calculating a ratio between the maximum value N_{M} and the number of points above the threshold N_{P} for each correlation signal.

10. The method according to claim 1, further comprising accumulating each correlation signal over a preset number of sample periods in accordance with the corresponding guard interval size for determining the maximum value N_{M} and the number of points above the threshold N_{P}.

11. A system for detecting a guard interval size among m possible guard interval sizes in a received OFDM signal, comprising:
an analog to digital converter, digitizing the received OFDM signal to form digital samples;
a correlation calculator, calculating a preliminary correlation signal from the digital samples, and generating a correlation signal corresponding to each of the m possible guard interval sizes by summing the preliminary correlation signal in accordance with the possible guard interval size;
a characteristic extractor, determining a maximum value N_{M} and a number of points above a threshold N_{P} in a sample period W for each correlation signal; and
an information combiner, choosing the guard interval size as the detected guard interval size from one of the m possible guard interval sizes according to the values N_{M} and N_{P} of each correlation signal.

12. The system according to claim 11, further comprising a metric value block, obtaining metric values of each correlation signal output from the correlation calculator, and providing the metric values to the characteristic extractor.

13. The system according to claim 12, wherein the metric value block is an absolute value block, obtaining absolute values of each correlation signal in the sample period W.

14. The system according to claim 11, wherein the characteristic extractor locates a maximum value position N, in the sample period W for each correlation signal.

15. The system according to claim 14, wherein the information combiner checks validity of the detected guard interval size based on the maximum value position N, obtained in a current and a previous sample period located by the characteristic extractor.

16. The system according to claim 15, wherein the information combiner determines the detected guard interval size as valid if the maximum value position N_{I} occurs periodically.

17. The system according to claim 15, further comprising a confirmation block coupled to the information combiner, confirming the detected guard interval size by counting a number of times the detected guard interval size passes the validity check and comparing the number with a confirm threshold.

18. The system according to claim 11, wherein the characteristic extractor sets the sample period W greater than 1.25 times the OFDM symbol period N (W>1.25N).

19. The system according to claim 11, wherein the information combiner chooses the guard interval size by calculating a ratio between the maximum value N_{M} and the number of points above the threshold N_{P} for each correlation signal (N_{M}/N_{P}).

20. The system according to claim 11, further comprising an accumulation block accumulating each correlation signal over a preset number of sample periods in accordance with the possible guard interval size, wherein the characteristic extractor determines the maximum value N_{M} and the number of points above the threshold N_{P} according to the accumulated correlation signals.

21. A synchronization monitoring mechanism, monitoring synchronization according to a guard interval size detected in a received OFDM signal, comprising:
an analog to digital converter, digitizing the received OFDM signal to form digital samples;
a correlation calculator, calculating a preliminary correlation signal from the digital samples, and generating a correlation signal corresponding to each possible guard interval size by summing the preliminary correlation signal in accordance with the possible guard interval size;
a characteristic extractor, determining a maximum value N_{M}, a number of points above a threshold N_{P}, and a maximum value position N_{I} for each correlation signal in a sample period W for each correlation signal;
an information combiner, choosing the guard interval size as the detected guard interval size from one of the possible guard interval sizes according to the values N_{M} and N_{P} of each correlation signal, and checking validity of the detected guard interval size based on the maximum value position N_{I}; and
a synchronization controller, counting a pass count for a number of times the detected guard interval size passes the validity check and a fail count for a number of times the detected guard interval size fails the validity check, confirming the detected guard interval size if the pass count exceeds a confirm threshold, checking if the confirmed guard interval size is different from the previous guard interval size, and re-synchronizing if the fail count exceeds a valid threshold or the confirmed guard interval size is different.

22. The synchronization monitoring mechanism according to claim 21, wherein the information combiner determines the detected guard interval size as valid if the maximum value position N_{P} occurs periodically.

23. The synchronization monitoring mechanism according to claim 21, wherein the information combiner chooses the guard interval size by calculating a ratio between the maximum value N_{M} and the number of points above the threshold N_{P} for each correlation signal (N_{M}/N_{P}).

24. The synchronization monitoring mechanism according to claim 21, wherein the characteristic extractor sets the sample period W to be 1.25 times greater than the OFDM symbol period N (W>1.25N).
